(19) United States
(12) Patent Application Publication
(10) Pub. No.: US 2011/0047614 A1
(43) Pub. Date: Feb. 24, 2011

(54) Permission management system for data accessing and method thereof

(76) Inventors: Chi-Feng Huang, Taipei (TW); Yuan-Lin Chiang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,635

(22) Filed: Aug. 19, 2009

(51) Int. Cl. G06F 12/14

(52) U.S. Cl. 726/19; 726/17

(57) ABSTRACT

The invention discloses a permission management system for data accessing and a method thereof, applicable to operating system. The method of permission management for accessing data comprises the steps of: first, monitoring an unoccupied drive letter in operating system; then, detecting a drive letter request event and actively executing an authorizing procedure to produce an access right of the drive letter; and stop monitoring the drive letter and allowing a user to access data corresponding to the drive letter according to the access right.

### FIELD OF THE INVENTION

The present invention relates to a system for data accessing and a method thereof, and particularly to a permission management system for data accessing and a method thereof.

### BACKGROUND OF THE INVENTION

In general, the removable storage device with the function of plug and play (PnP) becomes a main method of data accessing and exchanging in addition to the network, such as the Internet. However, such method of data accessing and exchanging derives other problems, such as mass documents and files may be duplicated by use of the flash memory device or the flash memory card without any security measures, such that even the whole database may be copied and backup directly. In addition, the risk of virus infection is dramatically increased due to the data accessing and exchanging via the removable storage device. Therefore, a permission management is necessary to solve the aforementioned problems.

### SUMMARY OF THE INVENTION

According to the aforementioned problem of the prior art, it is a primary objective of the present invention to provide a permission management system for data accessing and a method thereof to solve the security issue of data management.

Accordingly, a method of permission management for accessing data is provided and comprises the following steps. First, at least one unoccupied drive letter in an operating system is monitored. Then, a drive letter request event is detected and an authorizing procedure is actively executed to produce an access right of the drive letter. Subsequently, the drive letter is stopped from being monitored and a user is allowed to access the data corresponding to the drive letter according to the access right.

Wherein, detecting the drive letter request event of the drive letter may be achieved by a callback function, listening to a device change message of the operating system or I/O polling.

In addition, a permission management system for data accessing is provided and comprises a monitoring module, a detecting module, an active authorizing module and a data accessing module. The monitoring module is used to monitor at least one unoccupied drive letter in an operating system, and to stop monitoring the drive letter while an authorizing procedure is completed. The detecting module is used to detect a drive letter request event of the drive letter. The active authorizing module is used to execute the authorizing procedure to produce an access right of the drive letter. The data accessing module is used to allow a user to access data corresponding to the drive letter according to the access right.

Wherein, the detecting module can detect the drive letter request event of the drive letter by a callback function, listening to a device change message of the operating system or I/O polling.

In summary, the disclosed permission management system for data accessing and the method thereof may comprise one or more of the following advantages:
(1) An unauthorized user is not able to access data via an authorizing procedure, thereby managing data access effectively.
(2) The risk of virus infection in a system can be reduced via the mechanism of the permission management.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart of a method of permission management for accessing data according to the present invention;

FIG. 2 is a flow chart of a drive letter releasing event of the drive letter according to the present invention;

FIG. 3 is a block diagram of a permission management system for data accessing according to the present invention;

FIG. 4 is a schematic view according to an embodiment of the present invention; and

FIG. 5 is a flow chart according to the embodiment of the present invention.

### DETAILED DESCRIPTION OF THE PREFERRED EMBODIMENTS

The present invention will now be described with some preferred embodiments thereof. For the purpose of easy to understand, elements that are the same in the preferred embodiments are denoted by the same reference numerals.

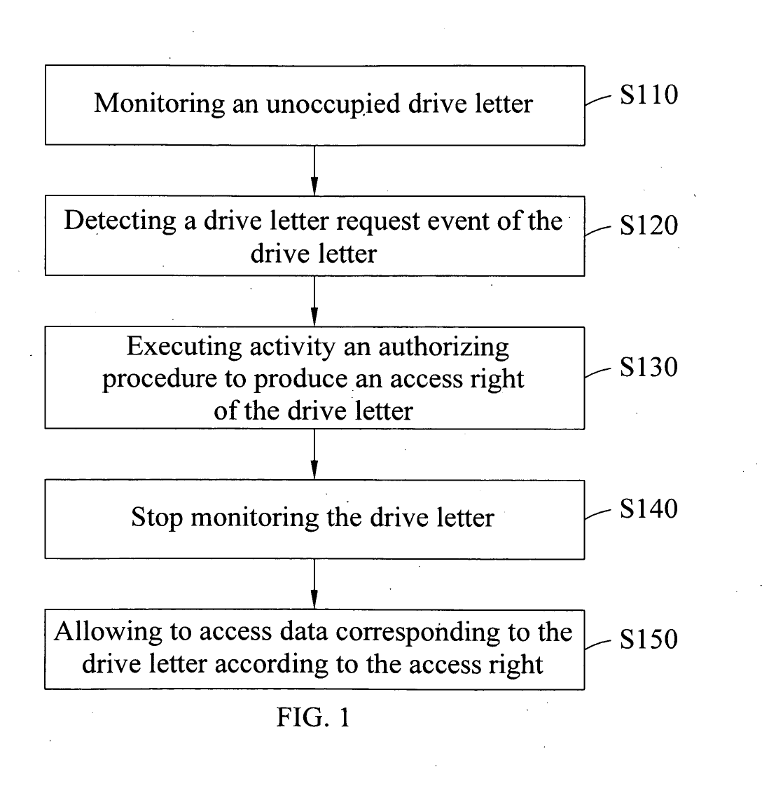

When a user wants to access data using a removable storage device, such as a USB flash device, an external storage device or a card reader, the removable storage device will be connected to a computer system. Then, the permission management for data accessing of the present invention may be executed. With reference to FIG. 1 for a flow chart of a method of permission management for accessing data according to the present invention, the method of permission management for accessing data comprises the following steps. In step S110, an unoccupied drive letter in an operating system is monitored. In step S120, a drive letter request event is detected. More specifically, the drive letter request event is detected in various methods, for example, by a callback function, listening to a device change message of the operating system or I/O polling. Wherein the method of detecting drive letter by a callback function further comprises the following steps. First, a function address of the callback function is registered in the operating system such that while the drive letter request event is taking place, the operating system calls the callback function according to the function address. In step S130, an authorizing procedure is actively executed to produce an access right of the drive letter. Wherein the access right comprises password authorization or biometrical authorization, such as fingerprint identification, iris recognition, retinal recognition, palm shape recognition, face recognition, voice recognition, vein recognition or DNA identification. The access right comprises denying accessing, or allowing reading, writing, executing or combinations thereof. In step S140, the drive letter is stopped from being monitored. In step S150, the data access corresponding to the drive letter is allowed according to the access right. Wherein in addition to each file, each folder file can be managed with different access rights.

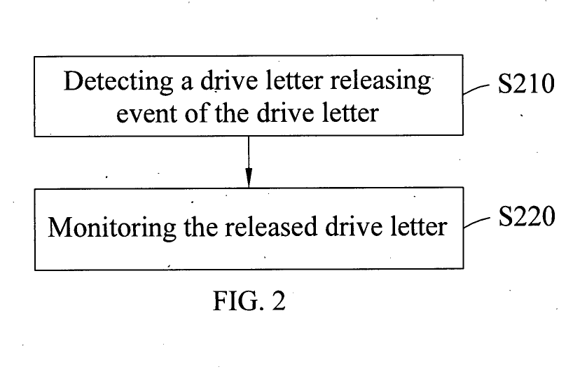

After the authorized user finishes operation, the connection between the removable storage device and computer system is disconnected. Meanwhile, the drive letter is released. Please refer to FIG. 2 for a flow chart of a drive letter releasing event of the drive letter according to the present invention, comprising the following steps. In step S210, the drive letter releasing event is detected. In step S220, the released drive letter is monitored.

When a user connects a removable storage device to a computer system, a permission management system for accessing data according to this present invention can be adopted.

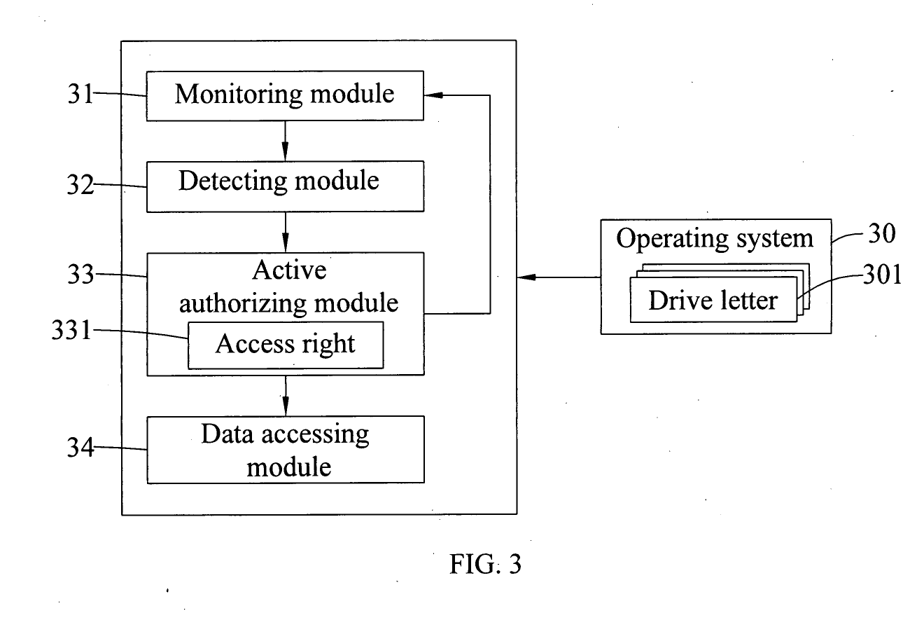

With reference to FIG. 3 for a block diagram of a permission management system for data accessing according to the present invention, the permission management system 3 is applicable to an operating system 30, and the operating system 30 comprises at least one drive letter 301. The permission management system 3 for data accessing comprises a monitoring module 31, a detecting module 32, an active authorizing module 33 and a data accessing module 34. The monitoring module 31 is used to monitor an unoccupied drive letter 301 in the operating system 30, and to stop monitoring the drive letter 301 while the authorizing procedure is completed. The detecting module 32 is used to detect a drive letter request event of the drive letter 301. The active authorizing module 33 is used to execute actively an authorizing procedure to produce an access right 331 of the drive letter 301 while the drive letter request event is detected by the detecting module 32. The data accessing module 34 allows a user to access data corresponding to the drive letter 301 according to the access right 331.

Wherein, the detecting module 32 can detect the drive letter request event in various methods, for instance, by a callback function, listening to a device change message of the operating system or I/O polling.

Furthermore, the active authorizing module 33 can execute actively an authorizing procedure by password authorization or biometrical authorization, such as fingerprint identification, iris recognition, retinal recognition, palm shape recognition, face recognition, voice recognition, vein recognition or DNA identification. The access right 331 comprises denying accessing, or allowing reading, writing, executing or combinations thereof. Moreover, in addition to each file, each folder file can be managed with different access rights 331.

While the user disconnects the removable storage device from the computer system, the detecting module 32 detects the drive letter releasing event and informs the monitoring module 31 to monitor the released drive letter 301.

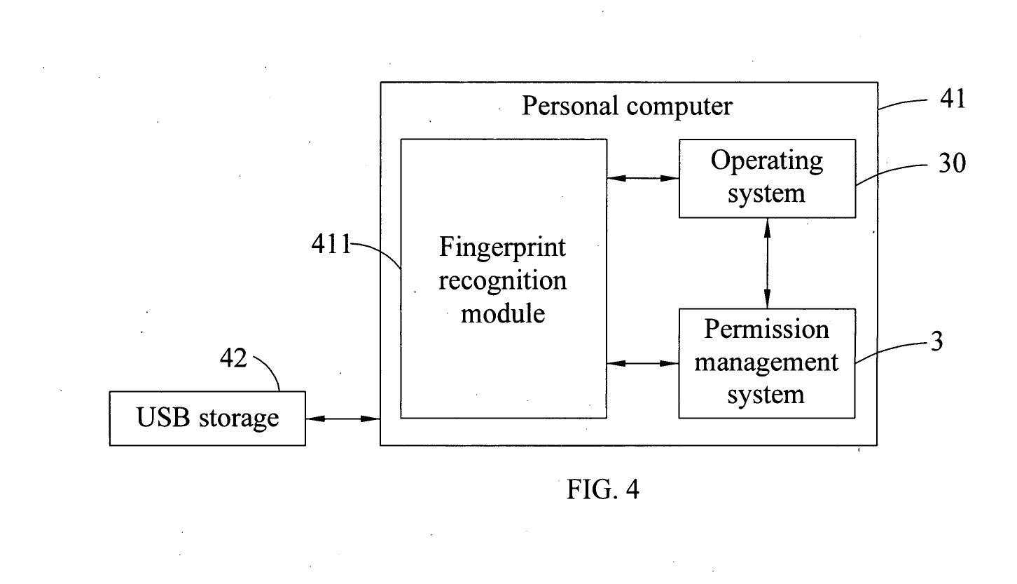

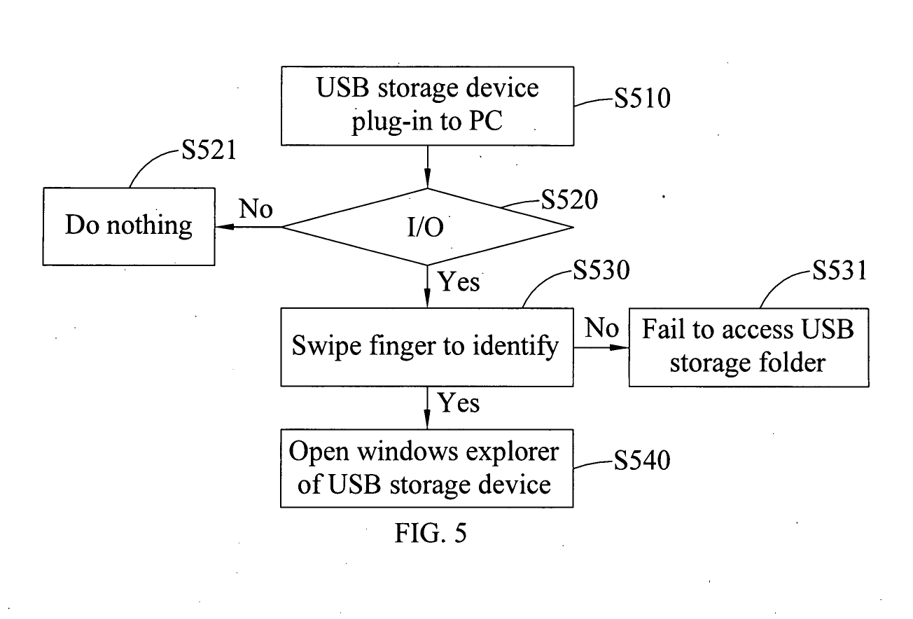

With reference to FIG. 4 and FIG. 5 respectively for a schematic view and a flow chart according to an embodiment of the present invention, a personal computer 41 comprises an operating system 30, permission management system 3 for data accessing, and a fingerprint recognition module 411 for inputting fingerprint data by a user. A USB flash device 42 connects to the personal computer 41 for accessing and exchanging data. FIG. 5 illustrates a flow chart of the permission management system for data accessing 3 executing a permission management after the USB flash device 42 connects to the personal computer 41. The steps are described as following in FIG. 5 with respect to FIG. 3 and FIG. 4.

In step S510, the USB flash device 42 connects to the personal computer 41. In step S520, an unoccupied input and output port is recognized by the personal computer 41, wherein whether an unoccupied input and output port is available or not is identified. If not, no action will be proceeded in step S521. If an unoccupied input and output port is available, in step S530, the detecting module 32 will detect the drive letter request event. Then, the active authorizing module 33 displays actively an authority prompting window to instruct the user to input fingerprint for executing the authorizing procedure in fingerprint recognition device 411 and producing access right 331. If the access right 331 is denying access, the step S531 is proceeded and the files or the folders of the USB flash device 42 are access denied. If the access right 331 is not denying access, the step S540 is proceeded in which the USB flash device 42 is accessed according to the corresponding to access rights, such as reading, writing, executing, or the combination thereof.

The present invention has been described with some preferred embodiments thereof and it is understood that many changes and,modifications in the described embodiments can be carried out without departing from the scope and the spirit of the invention that is intended to be limited only by the appended claims.

What is claimed is:

1. A method of permission management for accessing data, applicable to an operating system, comprising steps of:
monitoring at least one drive letter that is unoccupied in the operating system;
detecting a drive letter request event of the drive letter and actively executing an authorizing procedure to produce an access right of the drive letter; and
stopping monitoring the drive letter and allowing a user to access data corresponding to the drive letter according to the access right.

2. The method of permission management for accessing data as claimed in claim 1, detecting the drive letter request event of the drive letter is achieved by a callback function.

3. The method of permission management for accessing data as claimed in claim 2, wherein a function address of the callback function is registered in the operating system such that while the drive letter request event is taking place, the operating system calls the callback function according to the function address.

4. The method of permission management for accessing data as claimed in claim 1, wherein detecting the drive letter request event of the drive letter is achieved by listening to a device change message of the operating system.

5. The method of permission management for accessing data as claimed in claim 1, wherein detecting the drive letter request event of the drive letter is achieved by I/O polling.

6. The method of permission management for accessing data as claimed in claim 1, wherein the access right comprises: denying accessing, or allowing reading, writing, executing or combinations thereof.

7. The method of permission management for accessing data as claimed in claim 1, wherein the authorizing procedure comprises password authorization or biometrical authorization.

8. The method of permission management for accessing data as claimed in claim 7, wherein the biometrical authorization includes fingerprint identification, iris recognition, retinal recognition, palm shape recognition, face recognition, voice recognition, vein recognition or DNA identification.

9. The method of permission management for accessing data as claimed in claim 1, further comprising steps of:
detecting a drive letter releasing event of the drive letter; and
monitoring the drive letter.

10. A permission management system for data accessing, applicable to an operating system, the permission management system comprising:
a monitoring module monitoring at least one drive letter that is unoccupied in the operating system;
a detecting module detecting a drive letter request event of the drive letter;
an active authorizing module actively executing an authorizing procedure to produce an access right of the drive letter while the drive letter request event is detected by the detecting module; and
a data accessing module allowing a user to access data corresponding to the drive letter according to the access right;
wherein the monitoring module further stops monitoring the drive letter while the authorizing procedure is completed.

11. The permission management system for data accessing as claimed in claim 10, wherein the detecting module detects the drive letter request event of the drive letter by a callback function.

12. The permission management system for data accessing as claimed in claim 11, wherein a function address of the callback function is registered in the operating system such that while the drive letter request event is taking place, the operating system calls the callback function according to the function address.

13. The permission management system for data accessing as claimed in claim 10, wherein the detecting module defects the drive letter request event of the drive letter achieved by listening to a device change message of the operating system.

14. The permission management system for data accessing as claimed in claim 10, wherein the detecting module detects the drive letter request event of the drive letter achieved by I/O polling.

15. The permission management system for data accessing as claimed in claim 10, wherein the access right comprises: denying accessing, or allowing reading, writing, executing or combinations thereof.

16. The permission management system for data accessing as claimed in claim 10, wherein the active authorizing module executes an authorize procedure by password authorization or biometrical authorization.

17. The permission management system for data accessing as claimed in claim 16, wherein the biometrical authorization comprises fingerprint identification, iris recognition, retinal recognition, palm shape recognition, face recognition, voice recognition, vein recognition or DNA identification.

18. The permission management system for data accessing as claimed in claim 10, wherein the detecting module further detects a drive letter releasing event of the drive letter and informs the monitoring module to monitor the drive letter.
